(19) United States
(12) Patent Application Publication
(10) Pub. No.: US 2026/0087274 A1
(43) Pub. Date: Mar. 26, 2026

(54) REAL TIME LANGUAGE TRANSLATION APPLICATION

(71) Applicant: JPMORGAN CHASE BANK, N.A., New York, NY (US)

(72) Inventors: Amanda CARSON, Gahanna, OH (US); Dima KARDASHOV, Columbus, OH (US); Justin SCHLABACH, Lexington, OH (US)

(21) Appl. No.: 19/334,066

(22) Filed: Sep. 19, 2025

Related U.S. Application Data
(60) Provisional application No. 63/697,261, filed on Sep. 20, 2024.

(51) Int. Cl. G06F 40/58

(52) U.S. Cl. CPC G06F 40/58

(57) ABSTRACT

In some aspects, the techniques described herein relate to a method including: steps stored on a memory of an electronic communication device to be executed by a processor of the electronic communication device, the electronic communication device including a microphone and a display, the series of steps comprising: receiving a first speech through the microphone from a first speaker, detecting a spoken language from a first speaker, detecting a first direction of the first speaker, transcribing the spoken language to text, generating a first text translation, and displaying, on the display, the first text translation in the first direction of the first speaker.

### BACKGROUND

### 1. Field of the Invention

Embodiments generally relate to systems and methods for real time language translation.

### 2. Description of the Related Art

Language translation solutions span a range of modalities, including speech-to-text, text-to-speech, speech-to-speech, and image translation. These technologies have found application in diverse settings such as mobile devices, desktop computers, and dedicated translation hardware. In recent years, machine learning-based translation engines have further advanced effectiveness and accuracy, enabling automated rendering of spoken and written content in multiple languages with increasing speed.

In numerous customer-facing environments, ensuring equitable access to services regardless of a customer's preferred language has become an important objective. Financial institutions, government offices, healthcare providers, and retail establishments are exploring assistive translation tools to enable non-English speakers to engage with offerings and perform transactions effectively. The aim of these efforts is to provide a smooth experience that resembles native-language interactions, thereby fostering inclusion, minimizing misunderstandings, and enhancing operational workflows. On-demand functionality, multi-language support, and user-friendly interfaces are among the attributes prioritized in such systems.

Current systems for language translation are slow and cumbersome, requiring a device to slowly read back each portion of speech to a listener or requiring manual text input. If both persons of a conversation require translation, the wait for the read back on both sides of the conversation can significantly lengthen a conversation. In personal and business life, significant time of conversation participants would be saved if a better translation application were available. Thus, there is a need for an automated translation service that provides real time translation.

Despite advances in translation technology, many existing solutions rely on human interpreters, multi-step call center processes, or batch-style text processing, all of which introduce delays and added cost. Phone-based interpretation services often require queuing, incur per-minute charges, and prevent natural face-to-face dialogue. Some automated mobile applications depend on network connectivity and exhibit latency in speech recognition and output, limiting their utility in busy customer service scenarios. Offline translation devices may support only a handful of languages or lack robust error-correction capabilities, leading to incomplete or inaccurate exchanges. Embodiments of the present disclosure are generally directed to the field of language translation technology, and more particularly to systems and methods that facilitate substantially instantaneous bi-directional communication between speakers of different languages.

### SUMMARY

According to some embodiments, the techniques described herein relate to a method including: steps stored on a memory of an electronic communication device to be executed by a processor of the electronic communication device, the electronic communication device including a microphone and a display, the series of steps comprising: receiving a first speech through the microphone from a first speaker, detecting a spoken language from a first speaker, detecting a first direction of the first speaker, transcribing the spoken language to a first text, generating a first text translation, and displaying, on the display, the first text translation in the first direction of the first speaker.

Disclosed are systems and methods for real-time language translation, designed for use in customer-facing environments such as retail banking branches. The system comprises an electronic communication device equipped with a microphone, display, memory, and processor, which together enable the capture, transcription, translation, and display of spoken language in a manner that is both instantaneous and contextually oriented toward each speaker. Advanced features include automatic detection of spoken language and speaker direction, multi-party support with simultaneous translation and display for multiple speakers, and user interface enhancements such as pinch-to-zoom, real-time editing, and visual indicators for active speakers.

Disclosed systems and methods may include secure storage and management of translation session data, including audio recordings and transcriptions, with built-in mechanisms for anonymizing personally identifiable information and enforcing data retention policies. Additional capabilities include audio output of translated speech, image translation, session handoff between devices, and integration with marketing tools via QR code scanning. The system is designed to operate both online and offline, ensuring reliability and flexibility in various operational contexts.

Disclosed systems and methods address the limitations of conventional translation solutions by providing a robust, scalable, and user-friendly platform that promotes equity, efficiency, and inclusivity in environments where language barriers have traditionally impeded effective communication.

The steps may further comprise detecting a second speaker, detecting a spoken language from the second speaker, detecting a direction of the second speaker, transcribing the spoken language to a second text, generating a second text translation, and displaying the second text translation in the direction of the second speaker. In some embodiments, the first text and the second text may be displayed at the same time on the display in different orientations.

### BRIEF DESCRIPTION OF THE DRAWINGS

FIGS. 1A-1C illustrates system diagrams for real time language translation.

FIG. 2 illustrates a user interface for real time language translation.

FIG. 3 illustrates a user interface for real time language translation.

FIGS. 4A-4B illustrate a user interface for real time language translation.

FIG. 5 illustrates a user interface for real time language translation.

FIG. 6 illustrates a block diagram of a computing device for implementing certain embodiments of the present disclosure.

### DETAILED DESCRIPTION

Embodiments generally relate to systems and methods for real time language translation.

Real-time language translation systems, particularly in environments requiring seamless communication between individuals who speak different languages, may be used in retail situations such as for financial services, marketplaces, or through other interactions. Conventional approaches to language translation, such as phone-based interpreter services or handheld translation devices, suffer from significant limitations. These systems are often slow, cumbersome, and costly, requiring multiple steps to connect to an interpreter or relying on manual text input. Additionally, they fail to provide natural, face-to-face interactions, which are essential in customer service settings. For example, phone-based solutions involve lengthy processes to connect to interpreters, resulting in delays and poor customer experiences. Handheld devices, while portable, lack the sophistication to handle complex, domain-specific terminology and often require users to navigate unintuitive interfaces. These limitations create barriers for individuals with limited English proficiency (LEP), leading to ineffective transactions, financial challenges, and inequitable access to services.

The inventive concept disclosed herein significantly improves upon these prior approaches by introducing a real-time language translation application designed for deployment on electronic communication devices, such as banker tablets. This application leverages advanced machine learning (ML) models, including customized large language models (LLMs), to enable instantaneous bi-directional translation of spoken language. The system automatically detects the spoken language and directionality of speakers, transcribes speech into text, translates the text into the target language, and displays the translated text in orientations tailored to each speaker. By integrating features such as language auto-detection, real-time error correction, and transcription editing, the application ensures high accuracy and usability. Furthermore, the solution incorporates a secure web-based architecture, enabling the storage and retrieval of audio and transcripts for audit and refinement purposes while adhering to data privacy standards.

The technical solution also introduces a novel user interface design that facilitates natural interactions between speakers. For instance, the application can display transcribed and translated text in distinct spaces on the device's screen, oriented toward the respective speakers. This design enhances the conversational flow and reduces cognitive load for users. By addressing the inefficiencies and experience gaps of conventional systems, the disclosed technical approach provides a robust, scalable, and user-friendly solution that promotes equity and inclusivity in customer service environments.

Disclosed embodiments include an application or software program including a user interface that is accessible through an electronic communication device or computer. The electronic communication device or computer may include a connected speaker and microphone. The application or software program may receive speech through the microphone from one or more speakers. The application may include one or more steps of detecting a spoken language from a first speaker, detecting a first direction of the first speaker, transcribing the spoken language to text, translating the first text, displaying the first text in the direction of the speaker. The application may include further steps of detecting a second speaker, detecting a spoken language from the second speaker, detecting a direction of the second speaker, transcribing the spoken language to a second text, translating the second text, and displaying the second text in the direction of the second speaker. In some embodiments, the first text and the second text may be visible on a display, wherein the first text and the second text are in different orientations.

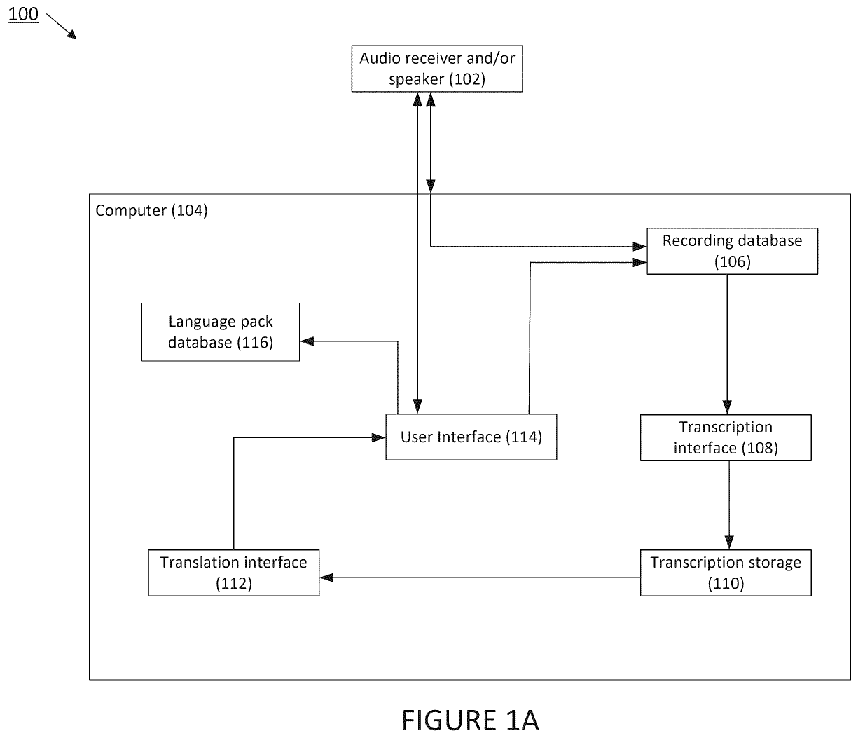

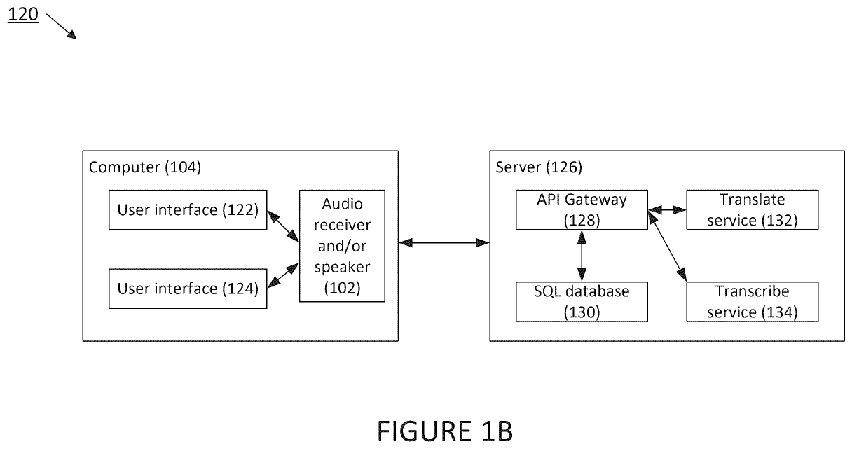

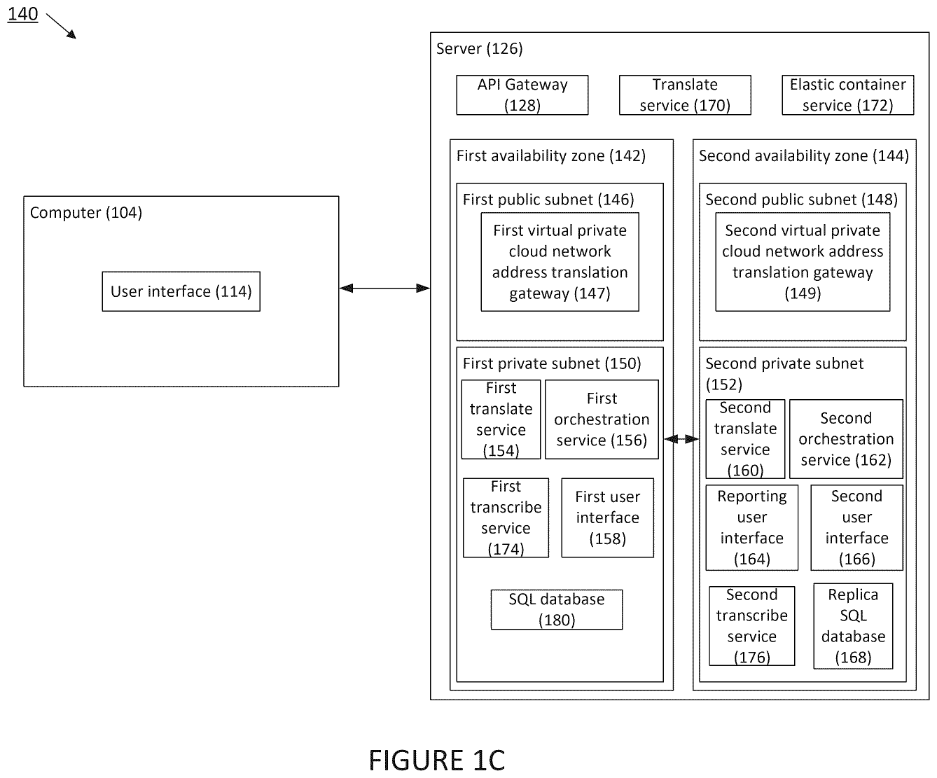

Referring to FIG. 1A, a system 100 for real time language translation is illustrated.

System 100 includes an application or software program executed by one or more processors of a computer 104 receiving speech from one or more users (e.g., a speaking user) through an audio receiver and/or speaker 102. The audio receiver may be a microphone. The audio receiver may be a shotgun microphone that captures sound from a specific source while minimizing noise from other angles. In some embodiments, two or more shotgun microphones may be used to capture input from specific sources around computer 104 (e.g., one per side of a rectangular or square display of a phone or tablet). Audio receiver and/or speaker 102 may be external to computer 104 (e.g., plugged in through a USB connection or similar) or internal to computer 104 (e.g., an integrated component). A recording may be generated and stored in memory when the speaking user provides speech input. The audio receiver and/or speaker 102 may output a translated speech through a speaker automatically once a translation is received or on demand as determined by one or more graphical user interfaces being activated/pressed (e.g., a button, toggle, entry associated with a graphical user interface of user interface 114).

The application or software program may store a recorded message in a recording database 106. The recording database 106 may be a temporary or permanent memory. The recorded message may be passed by the application or software program to transcription interface 108 to generate a transcription of the stored recording. Transcription interface 108 may generate the transcription. Transcription interface 108 may store the transcription in a transcription storage 110. The transcription storage 108 may be temporary or permanent memory. The transcription storage 108 may communicate with user interface 114 to show a translation of the speech input. The application or software program may provide the transcription to a translation interface 112 for translation of the transcription to another language. The transcribed and translated text may then be displayed through a display of user interface 114 of the computer 104. The translation may be passed from translation interface 112 to user interface 114 for display and/or to play an audio reading of the translation through audio receiver and/or speaker 102. In some embodiments, user interface 114 may interface with language pack database 116 to show characters (e.g., character encoding), graphical user interfaces, translation of common phrases, or similar. User interface 114 may pass translations and/or transcriptions through language pack database 116 before displaying/playing the translations on the display associated with user interface 114.

In some embodiments, a direction of a voice may be detected by audio receiver and/or speaker 102, and a display text of the display (e.g., of user interface 114) may be oriented to face a source of the voice (e.g., a speaker). In the case of more than one speaker, display text (e.g., of user interface 114) may be generated for each speaker on the same display. The display of user interface 114 may be a planar or generally planar surface, and the display text for each speaker may be provided in a space of the display in the direction of each speaker. In some embodiments, the display may receive an input through a graphical user interface (e.g., of user interface 114) button to indicate a direction of a speaker. In another embodiment, the microphone may be used to detect directionality of the voice.

In some embodiments, more spaces for more speakers may be generated on the display based on a new detected language, a new pitch or tone associated with a new speaker. The spaces may bisect a display of user interface 114 as many times as necessary, which each space being oriented towards each new speaker. A graphical user interface may be supplied to add, delete, or merge spaces.

In some embodiments, translation or transcription programs may be used locally on the computer or the electronic communication device.

In some embodiments, a transcription text of a first speaker may be displayed with an indication of a first speaker in the direction of the first speaker in addition to a translation text of a second speaker in the direction of the first speaker. This configuration may allow the first speaker to easily verify the transcription.

FIG. 1B illustrates a system diagram for real time language translation.

System 120 includes user interface 122 and user interface 124 executed by one or more processors of a computer or electronic communication device receiving speech from one or more users (e.g., a speaking user). User interfaces 122, 124 may be web user interfaces. A recording may be generated and stored in memory when the speaking user provides speech input received by audio receiver and/or speaker 102. Voice clips may be played by one or more speakers of the computer or electronic communication device. The computer or electronic communication device may communicate via interfaces (e.g., API gateway 128) over a wired or wireless connection with a server 126 such as a cloud-based server or a physical server. Server 126 may be a web server that hosts online content. API gateway 128 may interface with translate service 132, transcribe service 134, and structured query language (“SQL”) database 130. Server 126 may include a translate service and/or a transcribe service that translates and/or transcribes input voice clips that may be passed through API gateway 128 to computer 104 for display on user interfaces 122, 124. User interfaces 122, 124 may show and/or play a translation according to a direction or opposite a direction of a detected sound source (e.g., for a benefit of a recipient). User interfaces 122, 124 may alternate display of received input speech of a first speaker and translation of a second speaker for a benefit of the first speaker and/or the second speaker. User interfaces 122, 124 may be oriented towards the first speaker and/or the second speaker respectively. User interfaces 122, 124 may interact with translation service 132, transcribe service 134, and SQL database 130 to generate a written and/or vocal translation through API gateway 128 in real time.

FIG. 1C illustrates a system diagram for real time language translation.

System 140 includes a computer 104 including a user interface 114 executed by one or more processors of a computer or electronic communication device receiving speech from one or more users (e.g., a speaking user). Computer 104 may communicate with server 126 through API gateway 128. A recording may be generated and stored in memory when the speaking user provides speech input, and the recording may be passed through API gateway 128. Voice clips may be played by one or more speakers of the computer 104 in response to receiving a translation from server 126.

Server 126 may include a translate service, a transcribe service, a first availability zone 142 comprising a first public subnet 146 and a first private subnet 150, and a second availability zone 144 comprising a second public subnet 148 and a second private subnet 152. Each public subnet may include a Network Address Translation (NAT) Gateway (e.g., virtual private cloud network address translation gateways 147, 149) which is a service that allows instances in a private subnet to connect to the internet or other external services while preventing unsolicited inbound connections from the internet. Each private subnet 150, 152 may include a SQL database 180, 168, a serverless compute engine that runs containers, orchestration services 156, 162, and translate service instances 154, 160. Each of the private subnets may include transcribe services 174, 176. One of the private subnets may include a reporting user interface 164. The second private subnet 152 may include the SQL database 168 that may be automatically replicated from the SQL database 180 of the first private subnet 150.

The public subnets are segments of the cloud network that are configured to allow resources within it to communicate directly with the internet, typically through an internet gateway (e.g., gateways 147, 149). In this invention, public subnets are strategically used in each availability zone to facilitate secure and efficient access to external services while protecting sensitive backend components kept in the private subnets.

In some embodiments, computer 104 may execute the application to write timestamped pairs of the first source-language text and the first target-language text to a structured database (e.g., a SQL database) after automatically masking personally identifiable information (PII) contained in either text. In some embodiments, the application on the local device of computer 104 may mask the PII before it is sent to server 126. In some embodiments, the user may select information as PII or the system may automatically detect certain number or alphanumeric strings associated with passport numbers, credit card numbers, social security numbers, license information, or similar.

Server 126 may include node balancers including an application load balancer and a network load balancer. The application load balancer may balance requests from multiple computers (e.g., computer 102) across the user interfaces 158, 166 based on content. The network load balancer may distribute incoming network traffic across multiple private subnets.

Translate service 170 may be referenced by both first and second availability zones 142, 144 and specifically by first and second translate services 154, 160. Translate service 170 may include general, broad translate services 154, 160 may be focused on particular subsets of language typically used for everyday conversation. This may reduce compute and/or storage requirements and allow more efficient processing.

Elastic container service 172 may enable server 126 to package its translation and transcription applications, machine learning models, and supporting microservices into containers. These containers encapsulate all the necessary code, runtime, libraries, and dependencies, ensuring consistent operation regardless of the underlying infrastructure.

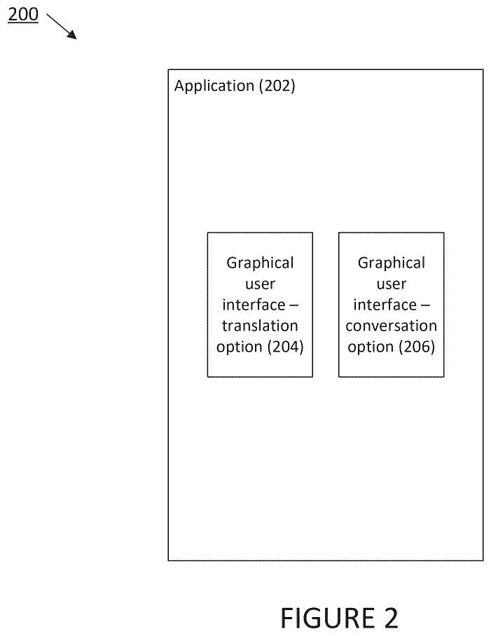

Referring to FIG. 2, a system 200 for real time language translation is illustrated. System 200 may be implemented on a computer or electronic communication device. System 200 may include a computer application.

System 200 may include one or more graphical user interfaces such as physical or electronic buttons to access either a translation application or a conversation application. Graphical user interface 204 may include a toggle, button, switch, or similar for a translation option. Graphical user interface 206 may include a toggle, button, switch, or similar for a conversation option. The translation option may link to an application instance for translating a single speaker. The conversation option may link to an application for translating a conversation option.

For FIGS. 1A-1C, translate and transcribe services may comprise a machine learning model that the application may reference to automatically detect, that may include a large language model (LLM) customized for domain-specific terminology and conversational context. The transcribe service may transcribe the received speech into text, which can be edited in real time by the user to correct errors or clarify meaning. Once the transcription is finalized, the application translates the text into the target language and displays the translation in a dedicated sector of the device's display, oriented toward the intended recipient. In multi-party scenarios, the display is dynamically partitioned into multiple sectors, each corresponding to a different speaker, with independent scrolling and orientation to maintain readability.

The user interface is designed to be intuitive and flexible, supporting both manual and automatic language selection, pinch-to-zoom gestures for enlarging text, and graphical controls for starting and stopping recording, editing transcriptions, and selecting input and output languages. Visual indicators may be provided to show which speaker is currently active, and the system can automatically allocate new display sectors when additional speakers are detected based on changes in pitch, tone, or language.

In some embodiments, the application also includes functionality for image translation, allowing users to capture images containing text and receive translations in their preferred language. Users can scan QR codes to access translated materials directly on a separate device such as a mobile phone.

All session data, including audio recordings, transcriptions, and translations, are securely stored in a structured database such as a SQL. The server may anonymize or pseudonymize personally identifiable information (PII) prior to storage, and enforces data retention policies that automatically delete records after a predefined period. The predefined period may be a period (e.g., around one minute) after no more speech input is received. The application may allow session handoff between devices, allowing for seamless transfer of ongoing translation sessions and associated data. For example, data of the conversation may be sent to a storage accessible by a profile of an application executed on a separate device so that users may access the conversation in the future.

In some embodiments, the translation or conversation application may operate in both online and offline modes, with local processing capabilities to ensure uninterrupted service even in the absence of network connectivity. Summary reports of translation sessions, including key themes, trends, and user feedback, can be generated for analysis and continuous improvement of the translation platform. Summary reports may be saved to the profile discussed above.

By integrating advanced machine learning, secure data management, and a user-centric interface, the present invention overcomes the limitations of conventional translation solutions. It provides a scalable, efficient, and inclusive platform that enhances communication, reduces operational barriers, and promotes equitable access to services for individuals with limited proficiency of a specific language or other language needs.

Referring to FIG. 1C, the two availability zones and two private subnets may form part of the system's cloud-based architecture, ensuring high availability, fault tolerance, scalability, and secure data management for real-time language translation services.

An availability zone refers to a distinct, isolated location within a cloud provider's infrastructure, typically within a single geographic region. By deploying system components across two separate availability zones, the invention ensures that if one zone experiences a failure or outage, the other zone can continue to operate, thereby maintaining uninterrupted service for users.

Within each availability zone, the system utilizes private subnets. A private subnet is a segment of the network that is not directly accessible from the public internet, providing an additional layer of security for sensitive operations and data. In this invention, each availability zone contains its own private subnet, and each private subnet hosts critical backend components such as SQL databases, serverless compute engines for running containerized translation and transcription services, orchestration services, and instances of the translation and transcription interfaces.

The SQL databases in each private subnet may be configured for automatic replication, meaning that data stored in the database of one subnet is continuously synchronized with the database in the other subnet. This replication ensures data redundancy and consistency, so that if one database becomes unavailable, the other can immediately take over without loss of data or service continuity.

Network Address Translation (NAT) gateways are deployed in the public subnets of each availability zone, allowing resources in the private subnets to securely access the internet for updates or external services, while preventing unsolicited inbound connections from the internet.

By leveraging this dual availability zone and dual private subnet architecture, the server may achieve robust operational resilience, secure handling of sensitive translation and transcription data, and the ability to scale services dynamically in response to user demand. This design is particularly important for environments such as retail banking branches, where continuous, secure, and reliable access to real-time language translation is essential for customer service and compliance.

Although two availability zones are shown, more than two availability zones may be provided in server 126.

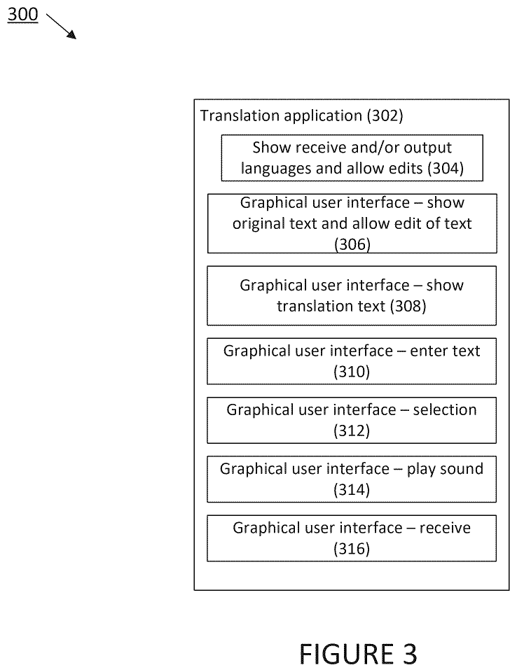

Referring to FIG. 3, a system 300 for real time language translation is illustrated. system 300 may be implemented on a computer or an electronic communication device.

Application 302 executed by the computer may include one or more graphical user interfaces of a translation application. The translation application 302 may include an indicator of the detected language and an indication of an output or display language. The translation application may provide one or more of a transcribed speech and a translation of the transcribed speech. The translation application may include a graphical user interface to edit the transcribed speech and allow editing through a user input (e.g., keyboard, touch selection, mouse) or speech input. In some embodiments, the translation application may receive speech after a graphical user interface 304, 316 of a microphone (e.g., a microphone button) is pressed. Graphical user interfaces 304, 316 may be displayed in a direction of a speaker. Once the graphical user interface of the microphone is released, the translation application may apply a text-to-speech application to provide a sound output of the translated text. A graphical user interface 306 to show a transcription of the spoken output and/or to allow editing of the same may be provided in a direction of a speaker. Graphical user interface 306 may display when new spoken words are received and transcribed and may remove older edit options when the new spoken words are received and transcribed. Graphical user interface 308 may show a translation text. Graphical user interface 310 may allow selection of entered text to be selected, deleted, and/or edited. Graphical user interface 312 may allow sound to be played based on the text. Graphical user interface 312 may allow a generated voice to read the translated text. As such, users may use the graphical users to interact with and quickly edit and generate translations.

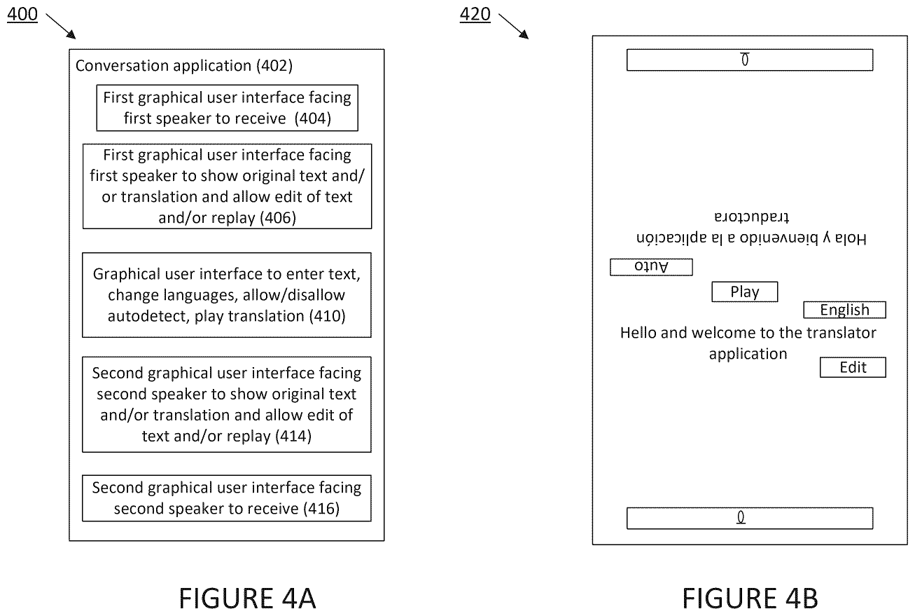

Referring to FIGS. 4A-4B, systems 400, 420 for real time language translation are illustrated. Application 402 may be implemented on a computer or electronic communication device.

Application 402 may include one or more graphical user interfaces of a conversation application. The conversation application may include a first space for a first speaker such as first graphical user interface facing first speaker to receive and/or show text as 404 and a second space for a second speaker such as second graphical user interface facing first speaker to receive and/or show text as 416. Graphical user interfaces 404, 416 may be on opposite sides of application 402 or on each side of application 402 (e.g., four sides if application 402 is displayed on a square or rectangular screen) or in individual spaces of application 402 (e.g., one for each detected speaker). The conversation application 402 may display transcribed and/or translated speech in the space in the direction of a speaker and a listener, respectively. In some embodiments, the conversation application may include a graphical user interface 406, 414 to edit the transcribed speech and allow editing through a user input or speech input. Once the edit is made, a speaker has stopped speaking for a period of time, or a graphical user interface of the microphone (e.g., associated with user interfaces 404, 416) is released, the translation application may apply a text-to-speech application to provide a sound output of the translated text. Graphical user interface 410 may be provided to enter text, change languages, allow or disallow autodetect and/or show which language is autodetected, and/or play a translation.

The conversation application 402 may show which language is being transcribed (e.g., while a speaker is speaking) and which language is being translated. The conversation application may indicate which speaker is currently speaking based on a direction of the speaker, e.g., through a highlighted, colored, or animated graphical user interface. As discussed above, a graphical user interface may be a microphone to indicate a direction of a speaker and/or as a button that can be pressed to begin the transcribing and translation of the speaker's words.

In some embodiments, the language spoken by a speaker may be auto-detected as disclosed herein.

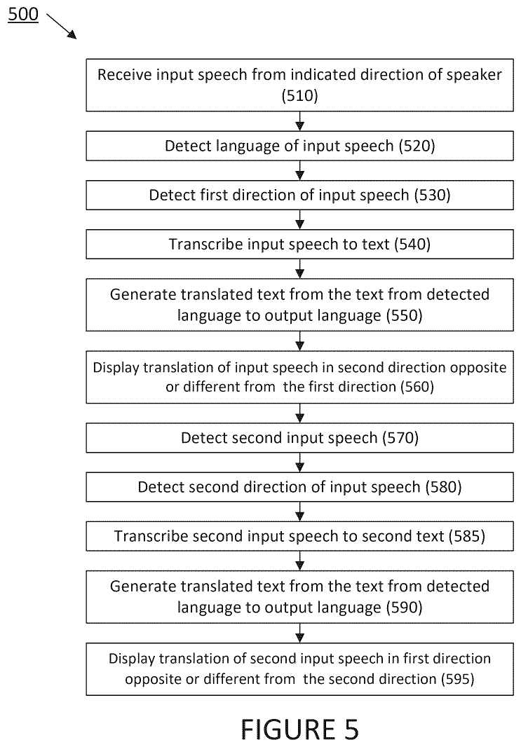

Referring to FIG. 5, a method 500 for real time language translation is illustrated. Method 500 may be as steps stored on a memory and executed by a processor, a computer or electronic communication device including the memory and the processor.

Method 500 may include step 510. In step 510, a microphone in operative communication with the computer or electronic communication device may receive input speech from an indicated direction of a speaker. In some embodiments, the indicated direction may be based on a user input. In other embodiments, the indicated direction may be based on a detected directionality of the speaker. The directionality may be based on one or more of an on-axis or off-axis sound, a level of received volume, and a pickup angle. In some embodiments, if directionality is determined for a first speaker, directionality can be assumed to be opposite the first speaker for the second speaker.

In some embodiments, the input speech may be stored in the memory as a recording.

In step 520, a language may be detected based on the first input speech. The language may be compared to known languages based on one or more of a frequency of a language based on a geographic area of the computer or electronic communication device, a comparison of a detected word or phrase to a database for a match to one or more known languages, and/or a user selection.

In step 530, a direction of the first input speech may be detected. In some embodiments, the input speech may be displayed on a display of the computer or electronic communication device in the detected direction. A first space may be displayed or generated, if it has not already been, for the detected first input speech.

In step 540, the first input speech may be transcribed and the transcribed text may be translated. In some embodiments, the steps may further include receiving an edit to the transcribed text.

In step 550, the first transcribed text of the first input speech may be generated and/or displayed in a direction of the first speaker on a display of the computer or electronic communication device. In some embodiments, a space on the display may be provided for the speaker, where the space is a subset of the display area for text. In some embodiments, the transcribed text may be displayed in an orientation to be read by the speaker.

In step 560, the first translated text may be displayed in a different or opposite direction of the input speech. A person opposite the first speaker may thus be able to read the transcribed and translated text. The person opposite the first speaker, like the first speaker, may be able to read their own input speech above the transcribed and translated text from the other speaker, as well as see any edits as they are made to the original text that are pushed to the translated text.

In step 570, a language may be detected based on speech from the second speaker. The language may be compared to known languages based on one or more of a frequency of a language based on a geographic area of the computer or electronic communication device, a comparison of a detected word or phrase to a database for a match to one or more known languages, and/or a user selection. The text (both from the first input speech and the second input speech) facing the second input speech may change based on the detected language.

In step 580, the direction of the second input speech may be detected. In some embodiments, the input speech may be displayed on a display of the computer or electronic communication device in the detected direction. A second space may be displayed or generated, if it has not already been, for the detected second input speech.

In step 585, the second input speech may be transcribed and the transcribed text may be translated. In some embodiments, the steps may further include receiving an edit to the transcribed text.

In step 590, the transcribed text of the second input speech may be generated and/or displayed in a second direction of the second speaker on the display of the computer or electronic communication device. In some embodiments, a second space on the display may be provided for the speaker, where the second space is a subset of the display area for text that excludes the first space. In some embodiments, the transcribed text may be displayed in an orientation to be read by the second speaker.

In step 595, the second translated text may be generated and/or displayed in a direction of the first speaker on a display of the computer or electronic communication device which may be in an opposite or different direction from the second direction. The translated text may be generated and/or displayed in the first space.

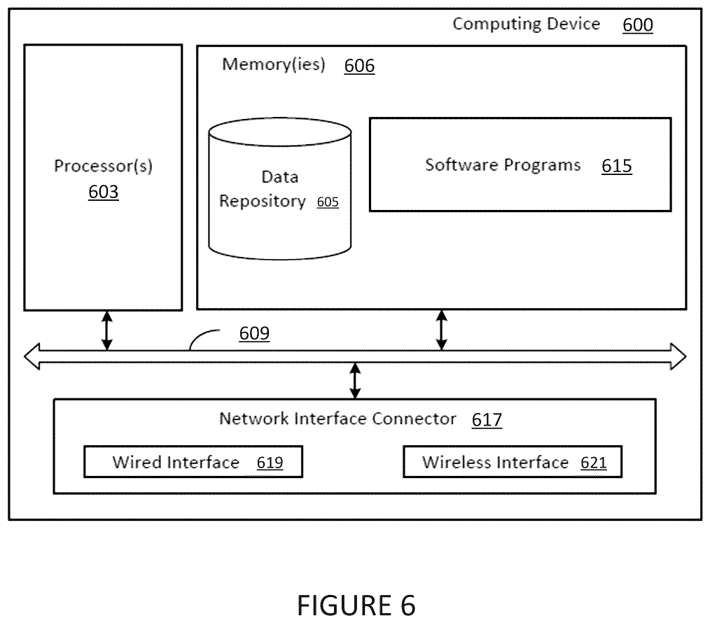

FIG. 6 is a block diagram of a computing device for implementing certain aspects of the present disclosure. FIG. 3 shows exemplary computing device 600. Computing device 600 may represent hardware that executes the logic that drives the various system components described herein. For example, system components such as a ML model engine, an interface, various database engines and database servers, and other computer applications and logic may include, and/or execute on, components and configurations like, or similar to, computing device 600.

Computing device 600 includes a processor 603 coupled to a memory 606. Memory 606 may include volatile memory and/or persistent memory. The processor 603 executes computer-executable program code stored in memory 606, such as software programs 615. Software programs 615 may include one or more of the logical steps disclosed herein as a programmatic instruction, which can be executed by processor 603. Memory 606 may also include data repository 605, which may be nonvolatile memory for data persistence. The processor 603 and the memory 606 may be coupled by a bus 609. In some examples, the bus 609 may also be coupled to one or more network interface connectors 617, such as wired network interface 619, and/or wireless network interface 621. Computing device 600 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method including steps stored on a memory of an electronic communication device to be executed by a processor of the electronic communication device, the electronic communication device including a microphone and a display, the series of steps comprising:
receiving a first speech through the microphone from a first speaker,
detecting a spoken language from a first speaker,
detecting a first direction of the first speaker,
transcribing the spoken language to text,
generating a first text translation, and
displaying, on the display, the first text translation in the first direction of the first speaker.

2. The method of claim 1, the steps further comprising:
detecting a second speaker,
detecting a spoken language from the second speaker,
detecting a direction of the second speaker,
transcribing the spoken language to a second text,
generating a second text translation, and
displaying the second text translation in the direction of the second speaker.

3. The method of claim 2, wherein the first text and the second text are displayed at the same time on the display in different orientations.

4. An electronic communication device comprising:
a microphone configured to capture live speech;
a display;
a memory storing computer-executable instructions; and
one or more processors operatively coupled to the microphone, the display, and the memory, the one or more processors being configured by execution of the instructions to:
receive, through the microphone, a stream of speech uttered by a first speaker;
automatically identify a spoken source language of the stream of speech;
determine, from audio characteristics of the stream of speech, a first geometrical direction of the first speaker relative to the device;
transcribe the stream of speech into first source-language text;
translate the first source-language text into first target-language text; and
render the first target-language text on the display oriented so that the text is readable from the first geometrical direction.

5. The electronic communication device of claim 4, wherein the microphone comprises a microphone array, and the first geometrical direction is determined via beam-forming analysis of the stream of speech.

6. The electronic communication device of claim 4, wherein the one or more processors are further configured to:
concurrently receive speech from a second speaker;
determine a second geometrical direction of the second speaker;
generate second target-language text corresponding to the speech of the second speaker; and
simultaneously present, on the display, the first and second target-language texts in respective orientation sectors that are individually rotated toward the first and second geometrical directions.

7. The electronic communication device of claim 6, wherein each orientation sector scrolls independently in a direction that keeps newly rendered text readable from the corresponding geometrical direction.

8. The electronic communication device of claim 4, wherein the automatic identification of the spoken source language may be overridden by manual language selection through a graphical user interface.

9. The electronic communication device of claim 4, further comprising a speaker, and wherein the one or more processors are configured to synthesize an audible rendition of the first target-language text and output the audible rendition through the speaker.

10. The electronic communication device of claim 4, wherein the display supports pinch-to-zoom touch gestures that enlarge the rendered target-language text without interrupting ongoing transcription or translation, and wherein edits made to the transcribed source-language text through the display are propagated in real time to update the rendered target-language text.

11. The electronic communication device of claim 4, wherein the one or more processors are further configured to write timestamped pairs of the first source-language text and the first target-language text to a structured database after automatically masking personally identifiable information contained in either text.

12. The electronic communication device of claim 4, wherein the one or more processors are configured to store audio recordings of the speech input and corresponding transcriptions and translations in a secure memory for audit and accuracy purposes.

13. The electronic communication device of claim 4, wherein the one or more processors are configured to detect a change in speaker by analyzing pitch, tone, or language, and to dynamically allocate a new display sector for each detected speaker.

14. The electronic communication device of claim 4, wherein the one or more processors are configured to provide real-time error correction by allowing a user to edit the transcribed text prior to translation.

15. The electronic communication device of claim 4, wherein the one or more processors are configured to automatically detect and display the currently active speaker using a visual indicator on the display.

16. The electronic communication device of claim 4, wherein the one or more processors are configured to enable session handoff by transferring session data, including transcriptions and translations, to a second device.

17. The electronic communication device of claim 4, wherein the one or more processors are configured to anonymize or pseudonymize personally identifiable information in stored transcripts and translations.

18. The electronic communication device of claim 4, wherein the one or more processors are configured to provide a graphical user interface for selecting input and output languages, starting and stopping recording, and editing transcriptions.

19. The electronic communication device of claim 4, wherein the one or more processors are configured to support image translation by capturing an image through a camera of the electronic device and translate text within the image into a selected target language.

20. The electronic communication device of claim 4, wherein the one or more processors are configured to store session data in a database with a data retention policy that automatically deletes records after a predefined period.
